(19) United States
(12) Patent Application Publication
(10) Pub. No.: US 2009/0177494 A1
(43) Pub. Date: Jul. 9, 2009

(54) Patient management method and system

(76) Inventor: Lorna W. Dunlop, Johnstone (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 12/007,025

(22) Filed: Jan. 4, 2008

(51) Int. Cl. G06F 19/00

(52) U.S. Cl. 705/3

(57) ABSTRACT

A method and system of patient recall management is disclosed comprising defining a set of disease related codes, each code being assigned to one or more predefined categories and having a predefined patient management plan including predefined time intervals at which appointments to meet with a predefined healthcare professional are due, each time interval including a time range at which the appointment may occur; assigning each patient record with one or more of the disease related codes according to results of a clinical assessment; scheduling and grouping appointments due, regardless of which code they belong to, according to the required healthcare professional, the appointment due date, taking into account the relevant time range, and any categories associated with the code, generating a set of appointments due for the patient.

### FIELD OF THE INVENTION

The present invention relates to a method and system of managing patients of a healthcare organisation and, particularly, to a method and system of managing the recall to the healthcare organisation for appointments.

### BACKGROUND OF THE INVENTION

Patient management systems which facilitate the organisation of appointments for both patients and healthcare professionals are known. These systems have a large number of functions one of which is “recall” management, which is the management of appointments for patients and particularly recurring appointments, or recalls.

Recall management functions of prior art patient management systems are “disease centred”. That is, they organise appointments and recalls based on the disease or ailment that the patient is suffering. As a result, any patient that has more than one disease or ailment is managed inefficiently both for the patient and the healthcare professionals, as they may be required to make separate appointments close together at the healthcare organisation. Furthermore, where two diseases require the same care delivery, duplication of care can result as the care is delivered according to the disease.

An object of the present invention is to obviate or mitigate the above issue with recall management.

### SUMMARY OF THE INVENTION

According to a first aspect of the present invention there is provided a method of patient management comprising:

defining a set of disease related codes, each code being assigned to one or more predefined categories and having a predefined patient management plan including predefined time intervals at which appointments to meet with a predefined healthcare professional are due, each time interval including a time range at which the appointment may occur;

assigning each patient record with one or more of the disease related codes according to results of a clinical assessment;

scheduling and grouping appointments due, regardless of which code they belong to, according to the required healthcare professional, the appointment due date, taking into account the relevant time range, and any categories associated with the code, generating a set of appointments due for the patient.

Preferably, one of the pre-defined categories is a clinical category and the step of defining the set of disease related codes further comprises assigning one or more clinical categories to each disease related code.

Preferably, one of the pre-defined categories is a recall priority category and the step of defining the set of disease related codes further comprises assigning a recall priority category to each disease related code.

Preferably, one of the pre-defined categories is a summary priority category and the step of defining the set of disease related codes further comprises assigning a summary priority category to each disease related code.

Preferably, the method further comprises defining a plurality of clinical data assessment templates, each template defining the clinical assessment data which must be collected during a particular clinical assessment.

Preferably, the step of defining the set of disease related codes further comprises assigning disease related codes to one or more clinical data assessment templates.

Preferably, the step of defining the set of disease related codes further comprises assigning a pre-set comment for each disease related code.

Preferably, the step of assigning each patient record with one or more of the disease related codes further comprises assigning a result to the patient record.

Preferably, the step of assigning each patient record with one or more of the disease related codes further comprises assigning a start date.

Preferably, the step of assigning each patient record with one or more of the disease related codes further comprises assigning end date.

Preferably, the method further comprises the step of generating a patient report indicating their associated disease related codes, patient management plan and appointments due and currently scheduled.

Preferably, the step of generating a patient report also includes a list of possible appointment dates and times according to the current status of an appointments system.

Preferably, the method further comprises the step of generating a healthcare professional report indicating the scheduled appointments for the relevant healthcare professional.

Preferably, the step of scheduling also groups appointments according to the required clinical assessment data.

Preferably, the method further comprises generating a clinical assessment data template, based on the patient management plan, for each scheduled appointment detailing the clinical assessment data which must be collected by the healthcare professional and the scheduled appointment.

Preferably, the method further comprises the step of generating a missed appointment report, detailing appointments that have been missed.

Preferably, the patient can be excluded from this report until a specific date.

Preferably the method further comprises generating a clinical care follow up plan report for patients summarising the disease related codes identified by one or more categories.

Preferably, the clinical care follow up plan summarises the disease related codes by a recall priority category.

According to a second aspect of the present invention there is provided a patient management system comprising:

a database for storing a set of disease related codes, each code having been assigned to one or more predefined categories and having a predefined patient management plan including predefined time intervals at which appointments to meet with a predefined healthcare professional are due, each time interval including a time range at which the appointment may occur;

means for storing patient records;

means for appointment scheduling;

means for associating each patient record with one or more of the disease related codes according to results of a clinical assessment;

means for scheduling and grouping appointments due, regardless of which code they belong to, according to the required pre-defined healthcare professional, the appointment due date, taking into account the relevant time range, and the categories associated with the code, generating a set of appointments due for the patient.

Preferably, one of the pre-defined categories is a clinical category and the means for associating each patient record further comprises means for associating a clinical category to each disease related code.

Preferably, one of the pre-defined categories is a recall priority category means for associating each patient record further comprises means for associating one or more recall priority categories to each disease related code.

Preferably, one of the pre-defined categories is a summary priority category means for associating each patient record further comprises means for associating a summary priority category to each disease related code.

Preferably, the system further comprises means for storing a plurality of pre-defined clinical data assessment templates, each template defining the clinical assessment data which must be collected during a particular clinical assessment.

Preferably, means for associating each patient record further comprises means for associating disease related codes to one or more clinical data assessment templates.

Preferably, means for associating each patient record further comprises means for associating a pre-set and a free text comment for each disease related code.

Preferably, means for associating each patient record further comprises means for associating assigning a result to the patient record.

Preferably, means for associating each patient record further comprises means for assigning a start date to the patient record for the disease related code.

Preferably, means for associating each patient record further comprises means for assigning an end date to the patient record for the disease related code.

Preferably, means for associating each patient record further comprises means for assigning a modifier to the patient record for the disease related code. (For example: right, left, bilateral etc.)

Preferably, means for associating each patient record further comprises means for assigning a free text extension to the patient record for the disease related code.

Preferably, the system further comprises patient report generation means which generates a patient report indicating the patients associated disease related codes, patient management plan and appointments due and currently scheduled.

Preferably, the patient report generation means further comprises means for including a list of possible appointment dates and times according to the current status of an appointments system in the patient report.

Preferably, the system further comprises healthcare professional report generation means which generates a healthcare professional report indicating the scheduled appointments for the relevant healthcare professional.

Preferably, means for scheduling and grouping appointments further comprises means to group appointments according to the required clinical assessment data.

Preferably, the system further comprises clinical assessment data template generation means, which generates a clinical assessment data template based on the patient management plan, for each scheduled appointment detailing the clinical assessment data which must be collected by the healthcare professional and the scheduled appointment.

Preferably, the system further comprises missed appointment report generation means which generates a missed appointment report, detailing appointments that have been missed by patients.

Preferably, the patient can be excluded from this report until a specific date.

Preferably the system further comprises clinical care follow up plan report generation means which generates a clinical care follow up plan report for patients summarising the disease related codes identified by one or more categories.

Preferably, the clinical care follow up plan summarises the disease related codes by a recall priority category.

According to a third aspect of the present invention there is provided a computer readable medium having computer readable instructions to instruct a computer to perform the method as recited according to the first aspect.

### BRIEF DESCRIPTION OF THE DRAWINGS

Embodiments of the present invention will now be described, by way of example only, with reference to the drawings, in which:

FIG. 1 is a schematic diagram of a patient management method according to the invention; and

FIG. 2 is a schematic diagram of processes involved in managing a patient including a patient management method and system according to the invention.

### DETAILED DESCRIPTION OF THE INVENTION

Patient administration or management systems are known, such as GPASS (General Practice Administration System for Scotland), but lack a number of key aspects, particularly concerning “recall” patient management, which is the management of appointments of patients. This is because prior art systems are disease centred rather than patient centred. The patient management system described herein allows for patient centred management through the intelligent use of disease codes and associated categories. As a result, patients receive a schedule of appointments which relate to all their ailments without duplicating tests or procedures unnecessarily.

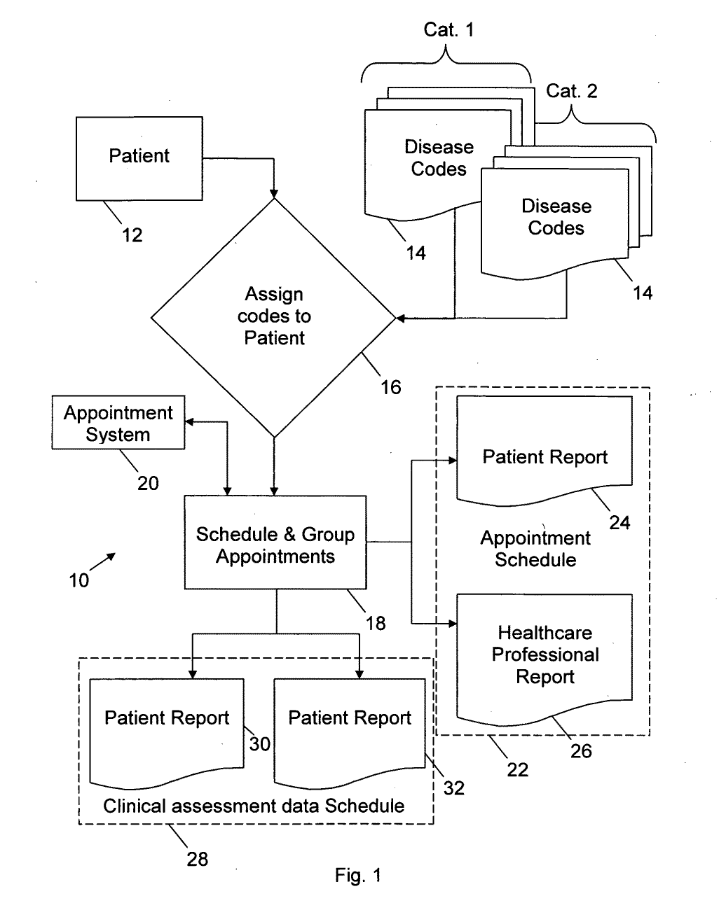

Referring to FIG. 1, a method of managing a patient 10 comprises a patient 12 and a pre-defined set of disease related codes 14. The disease codes can be assigned to one or more categories. By associating disease codes with categories, related disease codes can be grouped to enable intelligent scheduling of patient appointments.

For example, a disease code may be assigned to a “priority 1” recall priority category, which may define the priority level of that disease code. The recall priority may define the urgency of a particular appointment and therefore it may take precedence over disease codes with a lower recall priority. The disease code may also be assigned to a “blood disease” clinical category, grouping the disease related codes with other similar diseases and a summary priority category, such as high, medium and low, which defines the listing of the disease codes on any reports according to their importance. Furthermore, each disease related code can be associated with a predefined clinical assessment data template. A clinical assessment data template gives a healthcare professional guidance as to what data requires to be collected and, as such which tests or procedures require to be performed. By providing a template such as this, duplication of tests or procedures can be avoided thereby providing savings in cost, due to needless procedures, and time can be made.

It is also important for the system to be able to give information directly to the patient and therefore a pre-set and/or a free text comment may be assigned to each disease related code. This can then be provided with any report that the patient might received automatically or otherwise. It is also important to define a start date and end date to the patient record to enable the system to calculate the appropriate intervals and provide historical reports. Similarly, a result of management of a patient, of a particular assessment or assessment period can be entered into the system.

It should be appreciated that “disease” is used within the context of this specification to describe any condition, ailment or disorder that a patient may suffer from.

Disease codes 14 identify a particular disease and each have an associated patient management plan. The management plan includes details of various aspects of how the disease should be manages, such as, for example, appointments required and which healthcare professional needs to be available for the appointments, intervals between appointments, measurements or tests which much be performed at each appointment and how long each of the measurements or test are valid for. For each code there is a recommended date for review, an interval between reviews, person responsible and also whether a result is awaited. For each code a comments field will display any general pre-set comments and or free text patient specific comments. This report will include a free text area for specific patient communication.

During a clinical assessment 16, a patient 12 is assigned one or more disease codes 14 according to any identified diseases. Once a disease code 14 has been assigned to a patient 12, additional information can be added to the patient's record relating to that code. For example, patient specific details of why a particular code is to be followed up and or instruction or guidance to other team members on decisions to take if certain results obtained, such as, “refer back to General Practise Doctor (GP) if BP (Blood Pressure)>150/90 on more than 2 occasions less than 4 weeks apart”.

Once a patient 12 has been assessed, appointments can be organised in a scheduling step 18 to meet the requirements of the disease codes 14. This may be performed manually or automatically, if the information from the disease codes and the clinical assessment is sufficient.

In the context of the patient management system described herein, information can be assigned to disease related codes, patient records or other pieces of information. The preferred method of assigning or associating information is to alter a relevant field in a database record thereby linking that database record to a particular piece of information. For example, a database containing a table of disease related codes can have a unique identifier relating to each code. To assign a particular disease related code to a patient record in another database, the patient record is simply updated with the unique identifier of the disease related code in a known manner. As such, the reference to the disease related code has been entered in the patient record and any systems or persons analysing that patient record can then directly access the information contained in the disease related code records as well.

In particular, rules can be pre-defined which can assist in both manual and automatic generation of appointments for the patient 12. For example, if a patient 12 has been assigned more than one disease code in a particular category of disease, the disease code with a higher priority label should take precedence. So, a disease code with a requirement that blood pressure is taken every week can be grouped with a disease code that requires that blood pressure is taken every month, so that results from the weekly blood pressure measurements are used for the disease code which requires that blood pressure is taken monthly. Furthermore, where a disease code requires that an appointment is made for tests every three months within a window of two weeks, other disease code appointments which overlap that two week window can be arranged for the same time, avoiding the patient having to make more than one appointment. As such, the scheduling step 18 groups relevant appointments such that when a patient 12 calls or gets in contact in some other way to actually make the appointment, an up to date set of available dates and times can be accessed, as the system 10 is already aware which appointments are grouped together, which healthcare professionals are required for those appointments and, as such, when a suitable appointment can be arranged.

As mentioned above, scheduling also takes into account availability of the required healthcare professionals by interaction with an appointment system 20. As such, the patient management system 10 also operates as a healthcare team scheduling system. That is, each healthcare professional can view their appointments from the patient management system 10. Furthermore, the appointment system 20 can have details of various resources, such as a particular assessment machine. If the disease codes 14 indicate that a resource, such as said assessment machine, is required, scheduling also takes into account of the availability of the resource.

Once the scheduling step 16 has grouped relevant appointments, reports 22 can be generated. A patient report 24 details the various appointments that they must make and the time interval advised between encounters who the relevant healthcare professional is that must be present at the appointment, and, if the disease code 14 contains the relevant information, the reasons why a particular appointment or test is necessary. In this example, the patient report simply lists the appointments that they must make, that is, the responsibility for organising the appointments is left to the patient. It is envisaged that an alternative system may automatically assign appointments and that the patient would have the option to alter those if not suitable, within the prescribed time interval. If an appointment is not made, or the patient does not turn up for the appointment, then a missed appointment report is generated, or the patient will be included in the next missed appointment report. Furthermore, the report 24 also details any primary care appointments made and any secondary care or community appointments or referrals, if detailed in the appointment system 20 or the electronic patient record 34. Primary care describes the health services that play a central role in the local community, such as family doctors (GPs), pharmacists, dentists and midwives. Secondary care is a service provided by medical specialists who generally do not have first contact with patients, for example, cardiologists, urologists and dermatologists. A physician might voluntarily limit his or her practice to secondary care by refusing patients who have not seen a primary care provider first, or a physician may be required, usually by various payment agreements, to limit the practice this way. The report 24 will also include any free text communication to the patient entered by the healthcare professional, such as instructions or result explanations.

Furthermore, a healthcare professional report 26 can also be generated from data held in the system 10. This can list information for each healthcare professional or group of healthcare professionals as to what appointments are already confirmed, appointments due in a particular interval but not confirmed and appointments which either were not made altogether or missed and requiring a reminder or follow-up. Rules may also be defined to take a particular action as a result of information obtained from the healthcare professional report 26. For example, a missed deadline report could automatically generate a pre-defined reminder letter for each patient or advise review of the clinical management plan by a predetermined health care professional with regard to updating and sending to the patient.

In addition, clinical assessment data schedule reports 28 can also be generated. For example, an assessment report 30 can give details of the various assessments that have been and completed over a particular time period or list the test or assessments that are required in the coming appointments in a particular time period. Furthermore, a resource report 32 can look at the upcoming test or assessments due enabling a check as to whether the relevant resources are available or in stock, if they are consumables. Additionally, a clinical care follow up report can be generated which details the diseases suffered by the patient and the treatment plan given, which include information such as the appointments attended and the results to various assessments.

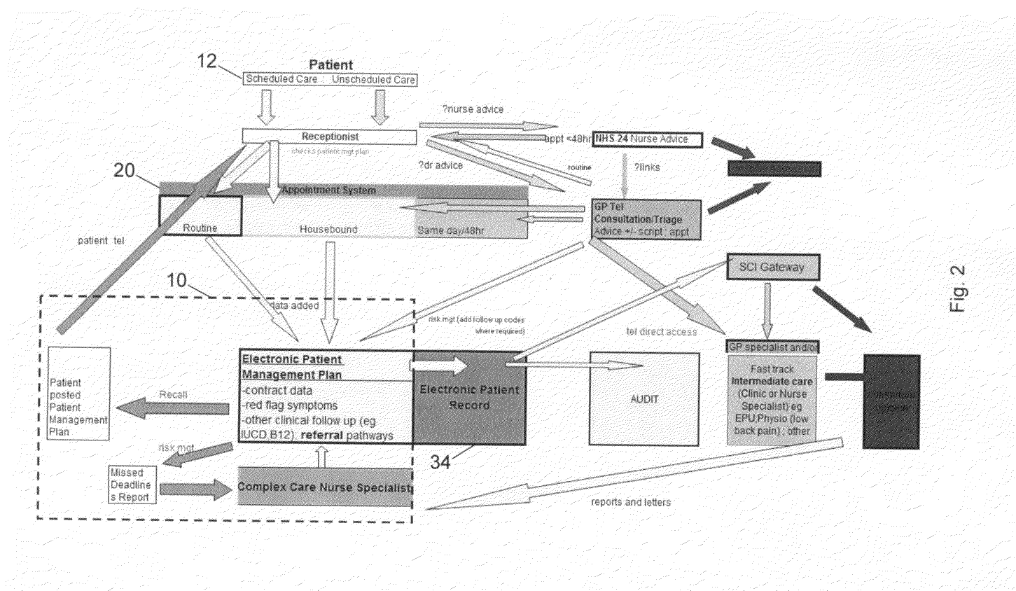

Referring to FIG. 2, a general framework of a healthcare system is shown incorporating the patient management system 10, the appointment system 20, an electronic patient record database 34 and the patient 12, as mentioned with relation to FIG. 1. FIG. 2 graphically demonstrates the amount of interactions required in a healthcares system and the large burden of management that the patient management system 10 takes on. “Recall management” within a patient management system is a new process as it captures multiple feedback elements of care, specific patient knowledge management within known guidelines and directly interacts with the patient who is then empowered to understand the complexities of their own individual health plan.

Modifications and improvements may be made without departing from the scope of the present invention.

I claim:

1. A method of patient management comprising:
defining a set of disease related codes, each code being assigned to one or more predefined categories and having a predefined patient management plan including predefined time intervals at which appointments to meet with a predefined healthcare professional are due, each time interval including a time range at which the appointment may occur;
assigning each patient record with one or more of the disease related codes according to results of a clinical assessment;
scheduling and grouping appointments due, regardless of which code they belong to, according to the required healthcare professional, the appointment due date, taking into account the relevant time range, and any categories associated with the code, generating a set of appointments due for the patient.

2. A method as claimed in claim 1, wherein one of the pre-defined categories is a clinical category and the step of defining the set of disease related codes further comprises assigning one or more clinical categories to each disease related code, assigning a recall priority category to each disease related code, assigning a summary priority category to each disease related code, assigning a pre-set comment for each disease related code, assigning a result to the patient record, assigning a start date and/or assigning an end date.

3. A method as claimed in claim 1, wherein the method further comprises defining a plurality of clinical data assessment templates, each template defining the clinical assessment data which must be collected during a particular clinical assessment.

4. A method as claimed in claim 3, wherein the step of defining the set of disease related codes further comprises assigning disease related codes to one or more clinical data assessment templates.

5. A method as claimed in claim 1, wherein the method further comprises the step of generating a patient report indicating their associated disease related codes, patient management plan and appointments due and currently scheduled.

6. A method as claimed in claim 5, wherein the step of generating a patient report also includes a list of possible appointment dates and times according to the current status of an appointments system.

7. A method as claimed in claim 1, wherein the method further comprises the step of generating a healthcare professional report indicating the scheduled appointments for the relevant healthcare professional.

8. A method as claimed in claim 3, wherein the step of scheduling also groups appointments according to the required clinical assessment data.

9. A method as claimed in claim 1, wherein the method further comprises generating a clinical assessment data template, based on the patient management plan, for each scheduled appointment detailing the clinical assessment data which must be collected by the healthcare professional and the scheduled appointment.

10. A method as claimed in claim 1, wherein the method further comprises the step of generating a missed appointment report, detailing appointments that have been missed.

11. A method as claimed in claim 10, wherein the patient can be excluded from the missed appointment report until a specific date

12. A method as claimed in claim 11, wherein the method further comprises generating a clinical care follow up plan report for patients summarising the disease related codes identified by one or more categories.

13. A method as claimed in claim 12, wherein the clinical care follow up plan summarises the disease related codes by a recall priority category.

14. A patient management system comprising:
a database for storing a set of disease related codes, each code having been assigned to one or more predefined categories and having a predefined patient management plan including predefined time intervals at which appointments to meet with a predefined healthcare professional are due, each time interval including a time range at which the appointment may occur;
means for storing patient records;
means for appointment scheduling;
means for associating each patient record with one or more of the disease related codes according to results of a clinical assessment;
means for scheduling and grouping appointments due, regardless of which code they belong to, according to the required pre-defined healthcare professional, the appointment due date, taking into account the relevant time range, and the categories associated with the code, generating a set of appointments due for the patient.

15. A system as claimed in claim 14, wherein one of the pre-defined categories is a clinical category and the means for associating each patient record further comprises means for associating a clinical category to each disease related code, means for associating one or more recall priority categories to each disease related code and/or means for associating a summary priority category to each disease related code.

16. A system as claimed in claim 14, wherein the system further comprises means for storing a plurality of pre-defined clinical data assessment templates, each template defining the clinical assessment data which must be collected during a particular clinical assessment.

17. A system as claimed in claim 16, wherein means for associating each patient record further comprises means for associating disease related codes to one or more clinical data assessment templates.

18. A system as claimed in claim 14, wherein means for associating each patient record further comprises means for associating a pre-set and a free text comment for each disease related code.

19. A system as claimed in claim 14, wherein means for associating each patient record further comprises means for assigning a result to the patient record, means for assigning a start date to the patient record for the disease related code, means for assigning an end date to the patient record for the disease related code and/or means for assigning a modifier to the patient record for the disease related code.

20. A system as claimed in claim 14, wherein means for associating each patient record further comprises means for assigning a free text extension to the patient record for the disease related code

21. A system as claimed in claim 14, wherein the system further comprises patient report generation means which generates a patient report indicating the patients associated disease related codes, patient management plan and appointments due and currently scheduled.

22. A system as claimed in claim 21, wherein the patient report generation means further comprises means for including a list of possible appointment dates and times according to the current status of an appointments system in the patient report.

23. A system as claimed in claim 14, wherein the system further comprises healthcare professional report generation means which generates a healthcare professional report indicating the scheduled appointments for the relevant healthcare professional.

24. A system as claimed in claim 14, wherein means for scheduling and grouping appointments further comprises means to group appointments according to the required clinical assessment data.

25. A system as claimed in claim 14, wherein the system further comprises clinical assessment data template generation means, which generates a clinical assessment data template based on the patient management plan, for each scheduled appointment detailing the clinical assessment data which must be collected by the healthcare professional and the scheduled appointment.

26. A system as claimed in claim 14, wherein the system further comprises missed appointment report generation means which generates a missed appointment report, detailing appointments that have been missed by patients.

27. A system as claimed in claim 14, wherein the system further comprises clinical care follow up plan report generation means which generates a clinical care follow up plan report for patients summarising the disease related codes identified by one or more categories.

28. A system as claimed in claim 27, wherein the clinical care follow up plan summarises the disease related codes by a recall priority category.

29. A computer readable medium having computer readable instructions to instruct a computer to perform the method as claimed in claims 1 to 13.
